(19) United States
(12) Patent Application Publication
(10) Pub. No.: US 2025/0231983 A1
(43) Pub. Date: Jul. 17, 2025

(54) SYSTEM AND METHOD FOR META-DATA EXTRACTION FROM DOCUMENTS

(71) Applicant: L&T TECHNOLOGY SERVICES LIMITED, Chennai (IN)

(72) Inventors: ANKIT MALVIYA, Betul (IN); MRIDUL BALARAMAN, Bangalore (IN); MADHUSUDAN SINGH, Bangalore (IN)

(21) Appl. No.: 18/531,745

(22) PCT Filed: Aug. 22, 2022
(86) PCT No.: PCT/IB2022/057840

§ 371 Date: Dec. 7, 2023

(51) Int. Cl. G06F 16/38; G06V 30/10; G06V 30/416

(52) U.S. Cl. CPC G06F 16/38; G06V 30/10; G06V 30/416

(57) ABSTRACT

A method of extracting meta-data from a document includes capturing style attributes from the document, identifying cell-wise location coordinates for text characters using page segmentation and border table extraction, and finding relationship between nearby cells using surrounding embedding by determining shortest distant text cell in top, left, right, and bottom direction. The method further includes applying Graph Convolution Network with Informative Attention (GCN-IA) for providing more attention to informative nodes for generating better representation of surrounding embedding and capturing a deep contextual meaning from text cells. A domain specific language model is utilized and improved by a domain aware tokenizer. The method includes capturing a complex visual layout of the document using the domain specific visual model, determining meta-data information, representing linguistic and visual contexts of the document, and correcting the extracted output by applying advanced-post processing on the extracted output from advanced language-visual model.

### TECHNICAL FIELD

This disclosure relates generally to extracting information from documents, and more particularly to a system and method of extracting meta-data from documents.

### BACKGROUND

Data extraction from documents is a well-known process, and widely used for its multiple advantages. Data extraction process includes multiple steps such as Optical Character Recognition (OCR) technique, which provides for electronic or mechanical conversion of images of typed, handwritten or printed text into a selectable document, a scanned document, an image of a document, etc. After generating OCR of the document, metadata associated with the text information present in the document may be extracted. It is possible to make this meta data extraction process more advance if we may handle it in the same analogy as the human brain works. For example, it looks on all the aspects of the information present in the document, such as the information may be available in terms of size, font, position, visual, and context etc.

In order to extract metadata from business documents, engineers have to define a large number of rules using natural language processing. These rules may be based on hard coded patterns. These NLP rules are also not very generic, they are specific to the particular document type, so defining the rules is a time consuming and repetitive process.

Therefore, an advanced language-visual model for meta-data extraction using multiple embeddings i.e., surrounding embedding, style embedding and region of interest from document image is desired.

### SUMMARY OF THE INVENTION

In an embodiment, a method of extraction of meta-data using multiple embeddings including surrounding embedding, style embedding, and region of interest from document image is disclosed. The method may include the utilization of spatial and surrounding information related to a specific attribute and writing style of documents in the same way that the human brain does while analyzing any document. The method may include the determination of the shortest distant text cell in top, left, right, and bottom direction of the particular text cell. After determining the shortest distant cells in all four directions, a compact surrounding embedding may be created, using a Graph Convolution Network Graph with Informative Attention (GCN-IA). This state of art allows the algorithm to adapt to the specific domain knowledge, document layout and grasp the spatial and semantic context of the content. The accuracy of this meta data extraction process may be improved further by efficiently handling the out of vocabulary problem in the process of text tokenization, by the creation of one or more secondary vocabulary during fine tuning of advanced language model. Once the metadata is extracted, advanced post processing steps are performed to improve the quality of the output.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a process flow diagram for meta-data extraction using an advanced language visual model, in accordance with an embodiment of the present disclosure.

FIG. 2 illustrates an example of output font name and corresponding document font style, in accordance with an embodiment of the present disclosure.

FIG. 3 illustrates an exemplary process for creating surrounding embedding, in accordance with an embodiment of the present disclosure.

FIG. 4 illustrates a process flow diagram of meta-data extraction from a document, in accordance with an embodiment of the present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

The disclosure pertains to meta-data extraction from a document using OCR modules. Normally available OCR modules lack the ability to capture style information such as character font-size, character font name, character font-type, font typography, region-type (table or free-text), number of upper characters, number of lower characters, number of special characters, number of spaces, number of digits, number of numeric words, number of alphabetic words, number of alphanumeric words and so forth. However, with the help of present OCR, this information can be captured. To preserve the style of writing document, style embedding is created by concatenating the above-mentioned information before creating word embedding from the text. This one-of-a-kind feature aids in the comprehension of the document's style layout. With the help of page segmentation and the border table extraction module, it is possible to capture cell-by-cell information for a specific attribute, such as a company's address or total invoice value. Surrounding embeddings are used to find relationship between nearby cells after capturing the cells for the attributes. We use surrounding embedding to find the relationship between nearby cells after capturing the cells for the attributes. Distance between each cell is determined in order to create the surrounding embeddings. Shortest distant text cell in the top, left, right, and bottom directions is detected after determining the distance. Further, a graph convolution network with informative attention is used to create a compact surrounding embedding by focusing on the left, right, top, bottom, and main text-cells, as well as their distance from the main text-cell.

A Graph Convolution Network with informative attention (GCNIA) focuses more on the contextually informative nodes and edges while ignoring the noisy nodes and edges. Generating a better representation of the surrounding embedding when compared to main nodes, this mechanism increases the importance of surrounding nodes' features. In the case of the address attribute, for example, the contact number will be more important than the total invoice value. GCN-IA is capable of capturing discriminative spatial features, and can also investigate the co-occurrence relationship between spatial and contextual features among nodes. This mechanism is similar to how a human brain works, and also aids in the capturing of spatial and semantic information between nearby cells.

The domain aware tokenizer reduces the out of vocabulary OOV problem during fine-tuning and improves the language model's performance while using the same number of parameters. Further, the domain aware tokenizer may create secondary vocabulary after creating the pretrained-tokenizer and vocabulary to link new words to existing words and reduce the OOV during fine-tuning of the advanced language model for down streaming tasks. A novel OOV sub word reduction strategy may be developed using token substitution method.

The domain specific language model and domain specific visual model generate an advanced language-visual model. It is possible to capture deep contextual meaning from text cells using a domain specific language model, and it is also possible to capture the complex visual layout of documents using a domain specific visual model. As a result, the detected features are capable of providing linguistic and visual contexts for the entire document, as well as capturing specific terms and design through detailed region information.

To improve the quality of the output from the advanced language-visual model, a novel post-processing methodology may be developed. Rule-based post-processing, Hashed Dictionary-based rapid text alignment, Machine Learning Language Model for Alphabetic Spelling Correction, and Dimension Unit conversion are all part of this methodology. It is possible to correct the erroneous extracted output by following these above-mentioned steps.

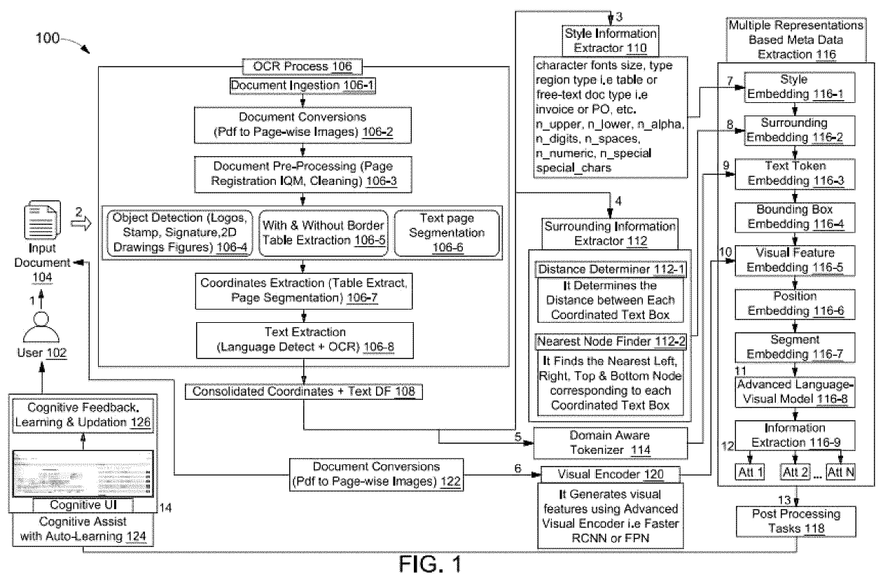

Referring to FIG. 1, a process flow diagram 100, for extraction of meta-data information from a document using an advanced language-visual model is disclosed, in accordance with an embodiment of the present disclosure. A user 102 may feed an input document 104 to the process flow. The input document 104 may be processed using an Optical character recognition (OCR) mechanism 106 by performing a series of execution steps. The execution steps may include the document ingestion 106-1 from the document. After the document ingestion, document conversions (pdf to page-wise images) 106-2 may take place, next execution step includes pre-processing 106-3 of the document. After preprocessing, object detection 106-4 may be carried out. The next steps entail table extraction 106-5, text page segmentation 106-6, coordinates extraction 106-7, and text extraction 106-8 from the input document. The outcome of the OCR mechanism 106 is in the form of consolidated coordinates and text data frame 108 and comprises of style information extractor 110, surrounding information extractor 112, and domain aware tokenizer 114. A part of the input data is encoded by advanced visual encoder 120 such as faster-RCNN or feature pyramid network (FPN) model etc. to extract visual features.

Style embedding 116-1 can be formed by concatenated together character font size, character font name, character font type, or font typography.

The domain aware tokenizer 114 may reduce out of vocabulary (OOV) problem during fine tuning and may enhance performance with same number of model parameters. The tokenizer process may involve two steps: (i) creation of pretrained tokenizer and vocabulary. For creation purpose following sequence of steps may be performed-(a) initialization of corpus elements with all characters in the text, (b) building of a language model on a training data using the corpus, (c) generation of a new word element by combining two elements from the current corpus to increase the number of elements in the corpus by one. Selection of the new word element out of all the possible ones that improve likelihood on the training data the most when added model vocabulary. (d) the step b and c may be repeated in sequence, until a predefined limit of word elements is reached or the likelihood increase falls below a certain threshold. (ii) the second step may include reduction of Out of vocabulary (OOV) during fine tuning of advanced language model for down streaming tasks and creation of a secondary vocabulary for linking new words to existing words. The second step may further include the following steps: (a) a complete text corpus analysis and search for all OOV. Whenever OOV occurs, keeping its record along with the context. (b) computing a counting table for both in-vocabulary & OOV sub-words for a priority mechanism in the strategy of reduction and occurrence of OOV sub words due to the OCR errors or scanning errors by one or two characters missing in the vocabulary, causing incomplete words or spellings. (d) use of token substitution method for building OOV sub word reducing strategy by using prior information.

Further, the process may include substituting a missing sub-word with an already available sub-word in a pre-trained model's vocabulary is different from substituting a semantically similar word because sub-words do not have associated meaning. The mask token may replace all OOV sub-words and passes them along with their context to the masked language model. The most likely sub-word from the counting table may be chosen based on the context. If two sub-words have the same probability of being chosen, the sub-word with the highest count takes precedence. The substitution word for OOV sub-words may be determined by calculating the m-gram minimum edit distance between remaining OOV sub-words and in-vocabulary sub-words for those OOV sub-words that are not substituted by any in-vocabulary sub-words. There may be a conflict between the m-gram edit distance between two sub-words, the sub-words with the highest count take precedence. Normal edit distance may result in a random sub-word, whereas m-gram minimum edit distance attempts to provide better substitution.

The generated OCR outputs will be further provided for creating: style embedding 116-1, surrounding embedding 116-2, text token embedding 116-3, bounding box embedding 116-4, visual feature embedding 116-5, position embedding 116-6, segment embedding 116-7, and these embeddings will be utilized in advanced language-visual model 116-8, for the task of information extraction 116-9.

Due to noisy background, low resolution, connected character, similar shapes character, thin font or new font, there is a possibility of occurrence of new problems such as incorrect spelling, text leakage, broken text etc. For handling these issues, the attributes which are extracted from advanced language-visual model are taken as inputs for post processing tasks 118. The outputs of the post processing are further validated by the cognitive user interface 14 for cognitive assistance with auto learning 124 and cognitive feedback learning and updation 126, which are finally perceived by the user 102.

For the generation of visual feature embedding 116-5, similar process may be followed as in the case of linguistic embedding except that text features are replaced by visual features. Advanced visual encoder such as faster-RCNN or feature pyramid network (FPN) model may be used to extract the visual features. Fixed size width and height of output feature map may be achieved by average pooling which may be flattened to obtain visual embedding. Positional information cannot be captured by CNN-based visual model, so position embeddings may be added to visual embeddings by encoding the ROI coordinates. Segment embeddings can be created by concatenating all visuals to the visual segment. The detected features can be linked to specific terms and designs through detailed region information, as well as providing visual contexts for the entire document image for the linguistic part. Object feature and location embeddings share the same dimension as linguistic embeddings.

Erroneous output may be corrected by using advanced post processing methodology. This methodology comprises of rule-based post processing mechanism, a hashed dictionary based rapid text alignment mechanism, a machine learning language model for alphabetic spelling correction, and a dimension unit conversion mechanism.

Rule based post processing mechanism relies on predefined rules, on the basis of these rules, it may be decided which words should be included in the output for each attribute. After parsing by the corresponding rule-based parser for most of the attributes, we first filter out m-grams that do not match the syntax of the particular attribute. The alphabetic m-gram, for example, will not work for the total value attribute or the date attribute.

In hashed dictionary based rapid text alignment technique for post-processing, some of the client provides dictionaries for some of the attributes such as currency keywords, company names or legal entities etc. These dictionaries can be utilized to correct the errors in the extracted OCR outputs related to these attributes. Heuristic search in the text, based on the dictionary words can be time consuming, hence alphabetic hashing mechanism for sorting the dictionary words may be used. After this, m-gram minimum edit distance for aligning the respective words from text to the hashed dictionary for correcting the erroneous words may be used.

A machine learning language model for alphabetic spelling correction may be used for correcting the alphabetic words. For this, first step includes substitution of the non-alphabetic words with some memorisable tokens. After this the next step is, training an attention-based machine learning language model with encoder-decoder for OCR error correction. In this model, at the decoder, multiple-input attention mechanism may be used to guide the decoder for aggregating the information from multiple inputs. This model takes incorrect OCR outputs as input and generates the corrected alphabetic text.

Dimension Unit conversion may be based on the client requirements, for some unit conversions on the dimensions. For example, meter to inches or kg to pound etc.

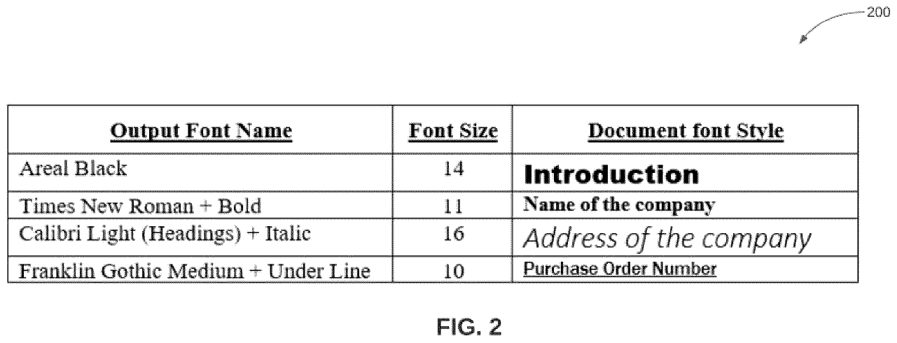

Referring now to FIG. 2, an example of output font name and corresponding document font style is shown.

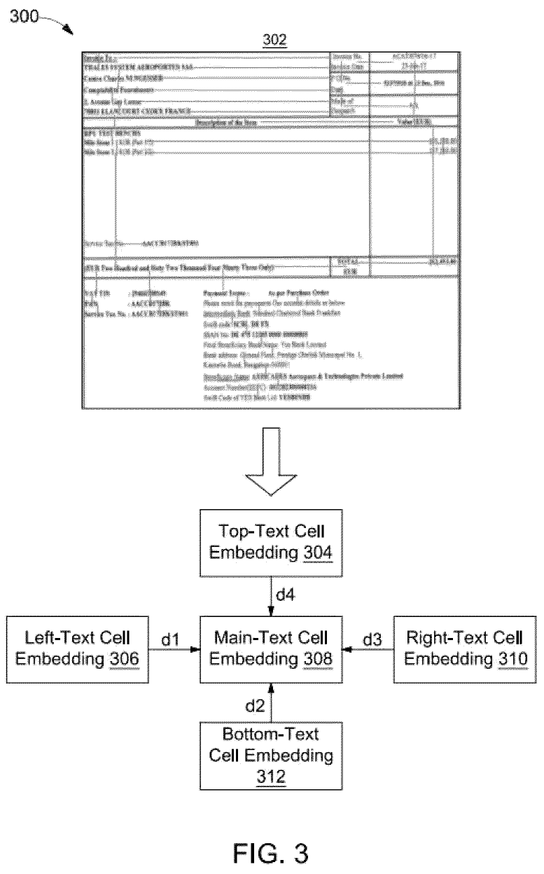

Referring now to FIG. 3, is an exemplary process for creating surrounding embedding 300, in accordance with an embodiment of the present disclosure. In this the input document 302 may be an invoice which helps in capturing the cells for the attributes and determining the relationship between the nearby cells. This further includes determination of distance between corresponding nodes. Further, based on the shortest distance between coordinate box and main text cell coordinate box. Text embedding for left 306, right 310, top 304, bottom 312 and main text cell 308 are created by using advance language-visual model.

The process may further include surrounding embedding creation using graph convolution network with informative attention, in accordance with an embodiment of the present disclosure. For giving more attention to informative nodes and generating better representation of surrounding embedding, mechanism of graph convolution network with informative attention (GCN-IA) is used. It enhances feature importance of surrounding nodes with respect to main nodes. It is capable of capturing discriminative spatial features and it can also investigate the co-occurrence relationship between spatial and contextual features among nodes. For example, in case of address attribute contact number will be more important than total invoice value.

This style embedding may comprise character font size along with its variety and its type of region with surrounding embedding. The surrounding embedding may comprise token and position embedding, visual feature embedding, bounded box embedding, position embedding, segment embedding, token embedding from the input document are inferenced using advance language-visual model which was trained through transfer learning and this advanced language-visual model performs information extraction, which further results in N number of attributes as an output of the process.

The style embedding encompasses document font style corresponding to various output font names. In this embodiment style characters may include following information such as special characters consisting of “&”, or “@”, or “#”, or “(”, or “)”, or “−”, or “+”, or “=”, or “*”, or “%”, or “.”, or “,”, or “\\”, or “/”, or “|”. Further, region type may be a table or a free text. Similarly, document type may be an invoice or a purchase order (PO) and so forth. The counting may include number of upper characters, number of lower characters, number of special characters, number of spaces, number of digits, number of numeric words, number of alphabetic words, number of alphanumeric words.

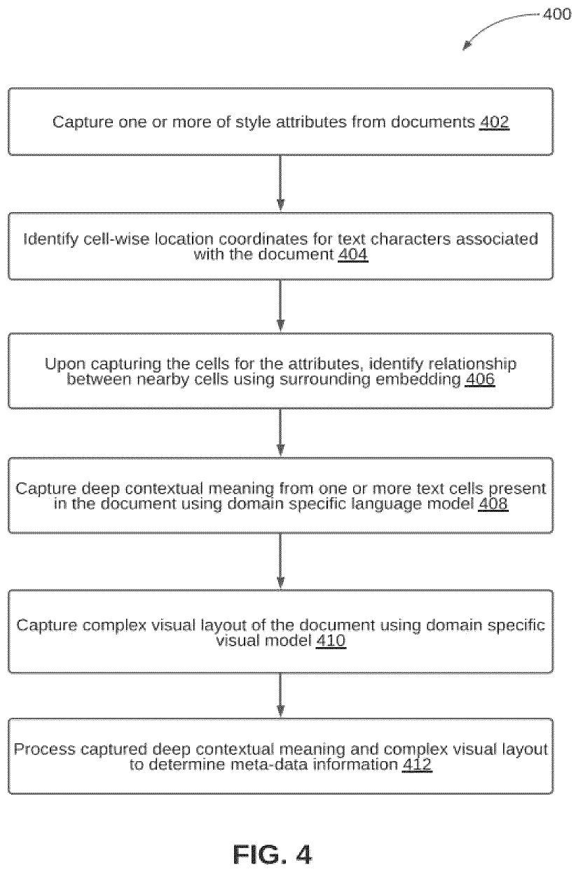

Referring now to FIG. 4, a process flow diagram of meta-data extraction from the document is illustrated, in accordance with an embodiment of the present disclosure. At step 402, one or more of style attributes may be captured from the documents may takes place. At step 404, cell-wise location coordinates for text characters associated with the document may be identified. After capturing the cells for the attributes, at step 406, the relationship between nearby cells may be identified using surrounding embedding. At step 408, deep contextual meaning from one or more text cells present in the document may be captured using domain specific language model. At step 410, complex visual layout of the document may be captured using domain specific visual model. At step 412, processing of the captured deep contextual meaning and complex visual layout may be carried out to determine meta-data information.

The present disclosure discusses advanced language-visual model for extraction of meta-data from the document. Advanced language model consists of domain specific language model and domain specific visual model. With the help of domain specific language model, it is possible to capture deep contextual meaning from the text cells and with the help of domain specific visual model it is possible to capture the complex visual layout of the documents. Hence, the detected features can provide linguistic and visual contexts of the whole document and also capable to capture the specific terms and design through detailed region information.

It is intended that the disclosure and examples be considered as exemplary only, with a true scope and spirit of disclosed embodiments being indicated by the following cla

What is claimed is:

1. A method of extracting meta-data from a document, the method comprising:
capturing, by a meta-data extraction device, one or more of style attributes from the document, where a style embedding is created by concatenating the captured one or more style attributes, and wherein the style embedding is created before creating a word embedding from text present in the document;
identifying, by the meta-data extraction device, a cell-wise location coordinates for text characters associated with the document, wherein the cell-wise location coordinates are indicative of inter-relationship of one or more cells of the document based on surrounding embedding;
capturing, by the meta-data extraction device, a deep contextual meaning from the one or more text cells present in the document using a domain specific language model;
capturing, by the meta-data extraction device, a complex visual layout of the document using a domain specific visual model; and
processing, by the meta-data extraction device, the captured deep contextual meaning and the complex visual layout to determine the meta-data information.

2. The method of claim 1, wherein the cell-wise location coordinates for the at least one attribute are captured using a page segmentation and a border table extraction mechanism.

3. The method of claim 1, wherein for determining the relationship between nearby one or more cells present in the document, a distance between each of the cells is determined, and wherein upon determination of the distance between each of the cells, a shortest distant text cell in top, left, right and bottom direction of the particular cell is determined.

4. The method of claim 1, wherein distance of each of top, left, right and bottom cell is determined with respect to a main text cell to create a compact surrounding embedding, wherein the surrounding embedding is created using a Graph Convolution Network with Informative Attention (GCN-IA).

5. The method of claim 1, wherein an erroneous output is corrected using an advanced post processing steps comprising at least one of a rule based post-processing mechanism, a hashed dictionary based rapid text alignment mechanism, a machine learning language model for alphabetic spelling correction, and a dimension unit conversion mechanism.

6. The method of claim 1, wherein the extracted output represents linguistic and visual contexts of the document, and wherein the extracted output captures one or more of specific terms and design of the document using a detailed region information mechanism.

7. The method of claim 1, further comprising:
performing advanced text tokenization by identifying one or more out-of-vocabulary (OOV) tokens based on token substitution, wherein the token substitution comprises:
substituting a missing sub-word with already available sub-word in the vocabulary of pre-trained model;
substituting OOV sub-words by mask tokens;
passing the mask tokens to the masked Language Model along with its context; and
for the OOV sub-words not substituted by any in-vocabulary sub-word, calculating m-gram minimum edit distance between remaining OOV sub-words and in-vocabulary sub-words to determine a substitution word for OOV sub-words.

8. The method of claim 1, wherein for reducing the out-of-vocabulary problem, one or more of secondary vocabulary is created for linking new words to existing words of the document during fine-tuning of an advanced language model for down streaming tasks.

9. A system of extracting meta-data from a document, comprising:
one or more processors;
a memory communicatively coupled to the processors, wherein the memory stores a plurality of processor-executable instructions, which, upon execution, cause the processors to:
capture one or more of style attributes from the document, where a style embedding is created by concatenating the captured one or more style attributes, and wherein the style embedding is created before creating a word embedding from text present in the document;
identify a cell-wise location coordinates for text characters associated with the document, wherein the cell-wise location coordinates are indicative of inter-relationship of one or more cells of the document based on surrounding embedding;
capture a deep contextual meaning from the one or more text cells present in the document using a domain specific language model;
capture a complex visual layout of the document using a domain specific visual model; and
process the captured deep contextual meaning and the complex visual layout to determine the meta-data information.

10. The system of claim 9, wherein the cell-wise location coordinates for the at least one attribute are captured using a page segmentation and a border table extraction mechanism.

11. The system of claim 9, wherein for determining the relationship between nearby one or more cells present in the document, a distance between each of the cells is determined, and wherein upon determination of the distance between each of the cells, a shortest distant text cell in top, left, right and bottom direction of the particular cell is determined.

12. The system of claim 9, wherein distance of each of top, left, right and bottom cell is determined with respect to a main text cell to create a compact surrounding embedding, wherein the surrounding embedding is created using a Graph Convolution Network with Informative Attention (GCN-IA).

13. The system of claim 9, wherein an erroneous output is corrected using an advanced post processing steps comprising at least one of a rule based post-processing mechanism, a hashed dictionary based rapid text alignment mechanism, a machine learning language model for alphabetic spelling correction, and a dimension unit conversion mechanism.

14. The system of claim 9, wherein the extracted output represents linguistic and visual contexts of the document, and wherein the extracted output captures one or more of specific terms and design of the document using a detailed region information mechanism.

15. The system of claim 9, wherein the one or more processors are configured to:
perform advanced text tokenization by identifying one or more out-of-vocabulary (OOV) tokens based on token substitution, wherein the token substitution is configured to:
substitute a missing sub-word with already available sub-word in the vocabulary of pre-trained model;
substitute OOV sub-words by mask tokens;
pass the mask tokens to the masked Language Model along with its context; and
for the OOV sub-words not substituted by any in-vocabulary sub-word, calculate m-gram minimum edit distance between remaining OOV sub-words and in-vocabulary sub-words to determine a substitution word for OOV sub-words.

16. The system of claim 15, wherein for reducing the out-of-vocabulary problem, one or more of secondary vocabulary is created for linking new words to existing words of the document during fine-tuning of an advanced language model for down streaming tasks.

17. A non-transitory computer-readable medium storing computer-executable instructions for extracting meta-data from a document, the computer-executable instructions configured for:
capturing one or more of style attributes from the document, where a style embedding is created by concatenating the captured one or more style attributes, and wherein the style embedding is created before creating a word embedding from text present in the document;
identifying a cell-wise location coordinates for text characters associated with the document, wherein the cell-wise location coordinates are indicative of inter-relationship of one or more cells of the document based on surrounding embedding;
capturing a deep contextual meaning from the one or more text cells present in the document using a domain specific language model;
capturing a complex visual layout of the document using a domain specific visual model; and
processing the captured deep contextual meaning and the complex visual layout to determine the meta-data information.

18. The non-transitory computer-readable medium of claim 17, wherein the cell-wise location coordinates for the at least one attribute are captured using a page segmentation and a border table extraction mechanism.

19. The non-transitory computer-readable medium of claim 17, wherein for determining the relationship between nearby one or more cells present in the document, a distance between each of the cells is determined, and wherein upon determination of the distance between each of the cells, a shortest distant text cell in top, left, right and bottom direction of the particular cell is determined.

20. The non-transitory computer-readable medium of claim 17, wherein distance of each of top, left, right and bottom cell is determined with respect to a main text cell to create a compact surrounding embedding, wherein the surrounding embedding is created using a Graph Convolution Network with Informative Attention (GCN-IA).
